(19) United States
(12) Patent Application Publication
(10) Pub. No.: US 2018/0101503 A1
(43) Pub. Date: Apr. 12, 2018

(54) METHOD AND DEVICE FOR ASSESSING SIGNALS

(71) Applicant: Ford Global Technologies, LLC, Dearborn, MI (US)

(72) Inventors: Norman Hansen, Aachen (DE); Norbert Wiechowski, Aachen (DE); Alexander Kugler, Aachen (DE); Stefan Kowalewski, Aachen (DE); Rainer Busch, Aachen (DE); Thomas Rambow, Aachen (DE)

(73) Assignee: Ford Global Technologies, LLC, Dearborn, MI (US)

(21) Appl. No.: 15/725,549

(22) Filed: Oct. 5, 2017

(30) Foreign Application Priority Data
Oct. 7, 2016 (DE) 102016219546.8

(51) Int. Cl. G06F 17/17

(52) U.S. Cl. CPC G06F 17/175

(57) ABSTRACT

The present disclosure relates to a method and a device for assessing signals that may be measurement signals as the result of a measurement which was previously carried out or of calculated values. In a method for assessing signals, the assessment is carried out based on whether the signals are in a determined tolerance range over a predefined period. The tolerance range is determined using at least one predefined geometric figure. The geometric figure is shifted along a desired curve, which describes the time-dependent profile of a desired value for the relevant signals, for the purpose of at least partially determining the tolerance range.

### CROSS-REFERENCE TO RELATED APPLICATIONS

This application claims priority to and the benefit of DE 1020162195468 filed on Oct. 7, 2016. The disclosure of the above application is incorporated herein by reference.

### FIELD

The present disclosure relates to a method and a device for assessing signals. More particularly, the signals being assessed may be, for example, measurement signals as the result of a measurement previously carried out or may be a calculated value, for instance in the form of simulation results.

### BACKGROUND

The statements in this section merely provide background information related to the present disclosure and may not constitute prior art.

In various system checks for software and/or hardware systems (e.g., systems for implementing a software function or measurement systems), signals are generated and recorded, and then a check is carried out in order to determine whether the recorded signals correspond to an expected signal within the scope of a predefined specification.

In particular, it is known practice to carry out the assessment based on a tolerance range. For example, if the recorded signal is within the tolerance range around a respectively predefined reference signal, the test is successful. Otherwise, an unsuccessful test or a defective system is determined. FIG. 1 illustrates an example of this basic concept, in which a recorded signal 11, a reference signal 12 and a specified tolerance range 13 are supplied to an evaluation or assessment unit 14 which generates an assessment result 15, as described above.

US 2008/0249731 A1 discloses, inter alia, an evaluation method for evaluating measured data points with respect to geometric tolerance ranges with uncertainty ranges being assigned to the measured data points. The geometric tolerance ranges are then modified based on the uncertainty ranges of the measured data points in order to define local acceptance zones for the measured data points. The measured data points are then collectively moved relative to the local acceptance zones. The measured data points are evaluated with respect to the local acceptance zones in the case of different relative positions between the measured data points and the local acceptance zones for a solution in which the measured data points are together within the local acceptance zones.

U.S. Pat. No. 6,665,080 B1 discloses, inter alia, a method for determining the deviations of measured geometric dimensions and/or the position of an object from predefinable desired values of the geometric dimensions and/or the position of the object. The measured values of the geometric dimensions and/or the position of the object are adapted to the desired values, before determining the deviations, while taking into account the predefinable tolerance values of the desired values of the geometric dimensions and/or the position of the object.

### SUMMARY

In one aspect, the present disclosure provides a method and a device for assessing signals which enable a higher degree of flexibility during signal assessment with respect to the predefinition of the respective framework conditions or specifications and, in particular, the predefinition of tolerance ranges which vary over time.

In a method for assessing signals, the assessment is performed based on a check as to whether the signals are in a determined tolerance range over a predefined period. The tolerance range is determined using at least one predefined geometric figure that is shifted along a desired curve, which describes the time-dependent profile of a desired value for the relevant signals, for the purpose of at least partially determining the tolerance range.

The present disclosure is based, in particular, on the concept of determining a tolerance range based on the geometric objects or figures (e.g., circles) when assessing signals (e.g., in the form of measurement or simulation results) and during the check for determining whether the relevant results are within this tolerance range. In this case, the tolerance range is calculated using geometric objects or figures on a desired curve in the execution period. The dimensions of the relevant geometric objects or figures may be changed over time, which in turn corresponds to a temporal change in the respectively applicable tolerances. Between said tolerance changes, the respective tolerance range can be determined based on an interpolation, with the result that a continuous tolerance range is obtained overall over time.

According to one aspect, the tolerance range is determined in such a manner that that range of values which is covered by the at least one geometric figure when shifting this figure is assigned to the tolerance range in a graph describing the dependence of a signal value on the time.

According to another aspect, the tolerance range is determined using at least two geometric figures which differ from one another.

According to yet another aspect, the tolerance range is determined by means of interpolation in a region of the desired curve which remains between these geometric figures.

According to one aspect, these geometric figures differ from one another in terms of their size.

According to another aspect, each of these geometric figures is shifted along the desired curve for the purpose of at least partially determining the tolerance range.

According to yet another aspect, the at least one predefined geometric figure comprises a circle.

According to one aspect, the at least one predefined geometric figure comprises an ellipse.

According to another aspect, the at least one predefined geometric figure comprises a rectangle.

According to yet another aspect, the at least one predefined geometric figure is a multidimensional figure.

According to one aspect, the multidimensional figure comprises a sphere.

According to another aspect, the multidimensional figure comprises an ellipsoid.

According to yet another aspect, the signals are measurement signals.

According to one aspect, the signals are simulation results.

The present disclosure also relates to a device for assessing signals. The assessment is carried out based on a check to determine whether the signals are in a predefined tolerance range. A device is configured to carry out a method having the features described above. With respect to advantages and advantageous configurations of the device, reference is made to the statements above in connection with the method according to the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an example block diagram of a conventional tolerance-based signal assessment process;

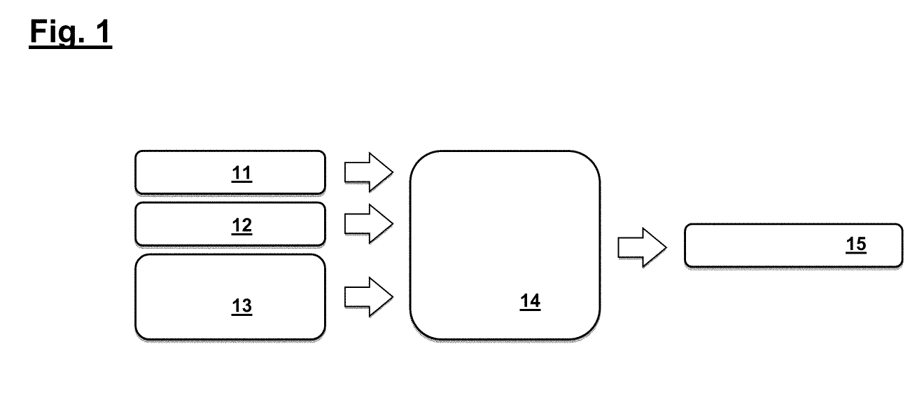

FIG. 2 is a schematic illustration of determining a tolerance range in accordance with the teachings of the present disclosure;

FIGS. 3A and 3B are schematic illustrations of an exemplary signal assessment in accordance with the teachings of the present disclosure;

FIG. 4 is a schematic illustration for generating or determining a tolerance range with a temporally varying tolerance in accordance with the teachings of the present disclosure;

FIGS. 5A and 5B are schematic illustrations of rectangles being used as geometric objects or figures for determining the tolerance range in accordance with the teachings of the present disclosure; and

FIG. 6 is a block diagram of a signal assessment process in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

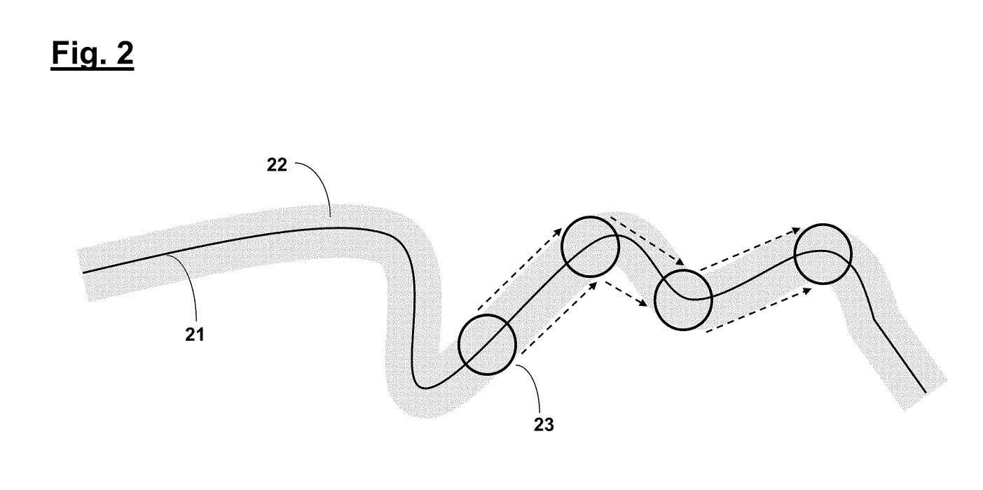

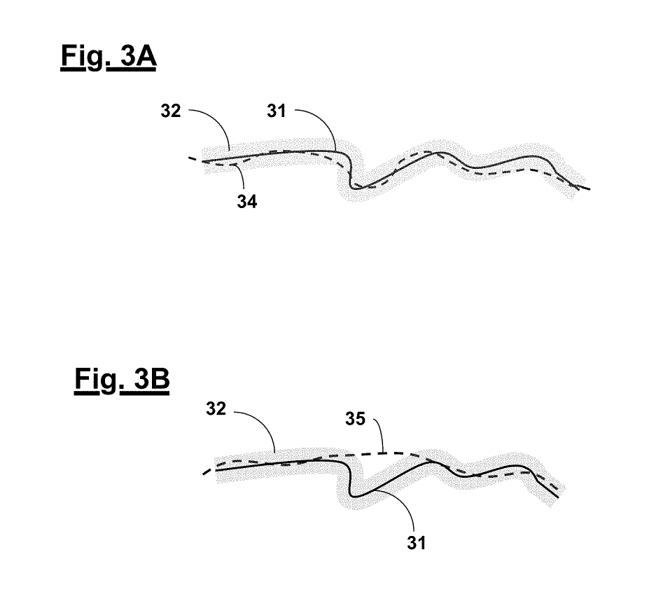

In one aspect of the present disclosure, the determination of a tolerance range (FIG. 2) which is carried out within the scope of a method according to the teachings of the present disclosure and the signal assessment (FIGS. 3A and 3B) based on said determination are described below with reference to FIG. 2 and FIGS. 3A and 3B.

A tolerance range is calculated or determined using geometric objects or figures (e.g., circles) which, on a desired curve (designated “21” in FIG. 2) during an execution period, indicates the permitted value deviation over this execution period. For example, the geometric objects or figures are circles 23 which are moved or shifted along the desired curve 21 in the direction of the dashed arrows to determine a tolerance range 22.

Based on the tolerance range 22, recorded signals (e.g., measured or simulated signals) are then assessed. Specifically, a successful test or a positive assessment result is determined if the recorded signal is within the tolerance range 22 throughout the execution period. Conversely, if the recorded signal is outside of the tolerance range (i.e., “leaves” the tolerance range) at any point (i.e., at least temporarily), an unsuccessful test or a negative assessment result is determined. In the example of FIG. 3A, a recorded signal 34 is within a tolerance range 32 generated along a desired curve 31 during the execution period, and therefore, the result is determined as a positive assessment result or a successful test. In contrast, in FIG. 3B, a recorded signal 35 is temporarily outside the tolerance range 32, and therefore, the result is determined as an unsuccessful test or a negative assessment result.

It should be pointed out that the use of circles as geometric objects or figures for determining the tolerance range according to the present disclosure is only exemplary and any desired geometric figures, such as rectangles, can also be used in principle. In the case of a circle, the tolerance value respectively used to generate the tolerance range corresponds to the Euclidean distance from the reference signal, which in turn corresponds to the circle radius.

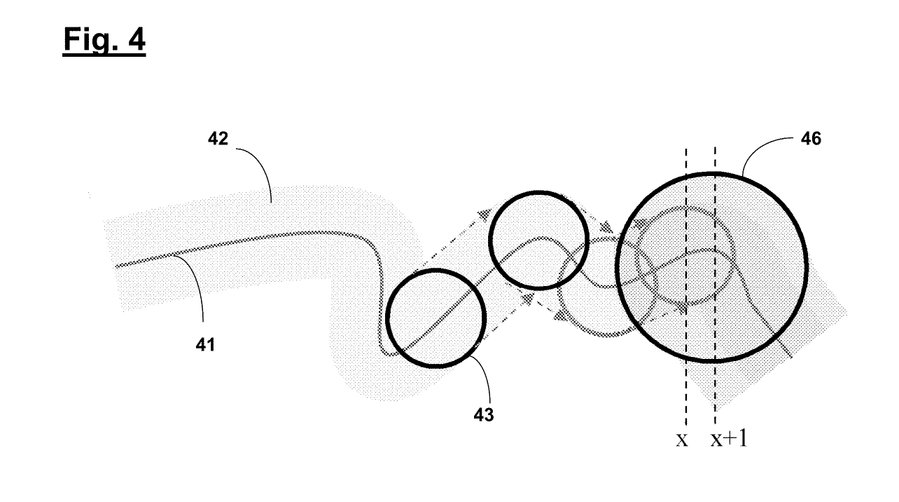

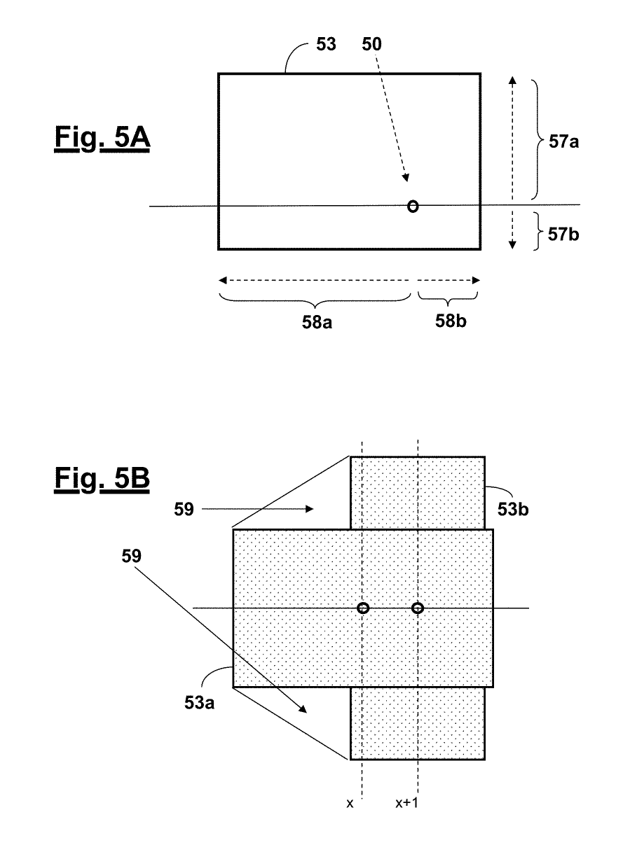

As described below with reference to FIGS. 4, 5A, and 5B, the concept according to the present disclosure now advantageously also makes it possible, in particular, to change the respective tolerance range over time since only the dimensions of the geometric objects or figures used to determine the tolerance range must be changed over time for this purpose. In this case, the tolerance range can be determined between the respective tolerance changes by means of interpolation, thus resulting in a continuous tolerance range over time.

FIG. 4 shows a schematic illustration similar to FIG. 2 for generating a tolerance range in accordance with the teachings of the present disclosure. Here, a temporal change is effected by temporally varying the geometric dimension of the object used to determine a tolerance range 42 about a desired curve 41 (i.e., a specified reference signal). In the specific exemplary example, the geometric objects or FIGS. 43 and 46 are used to determine the tolerance range 42 and are circles. The circle radius is increased between sampling times “x” and “x+1.” The tolerance range can be determined by means of interpolation between the sampling times “x” and “x+1”, with the result that a continuous tolerance range is obtained overall.

In one aspect, referring to FIGS. 5A an 5B, rectangles are used as geometric objects or figures for determining the tolerance range. For example, in FIG. 5A rectangle 53 is used and in FIG. 5B rectangles 53a and 53b are used. By using rectangles, it makes it possible to specify different, possibly uncorrelated, tolerance values with respect to the temporal deviation (i.e., at earlier or later times) and value deviations (i.e., to smaller or larger values). In this case, tolerance values for larger or smaller signal values are designated “57a” and “57b”; whereas temporal deviations at earlier or later times (i.e., to the left or right along the time axis) are designated “58a” and “58b”, the respective deviations being based on a signal value 50. To have greater tolerance changes, the geometric objects or figures can be interpolated according to FIG. 5B to the effect that a tolerance range 59 is added. That is, the outermost boundary points of two geometric objects are connected to one another via any desired connections, in particular connecting lines.

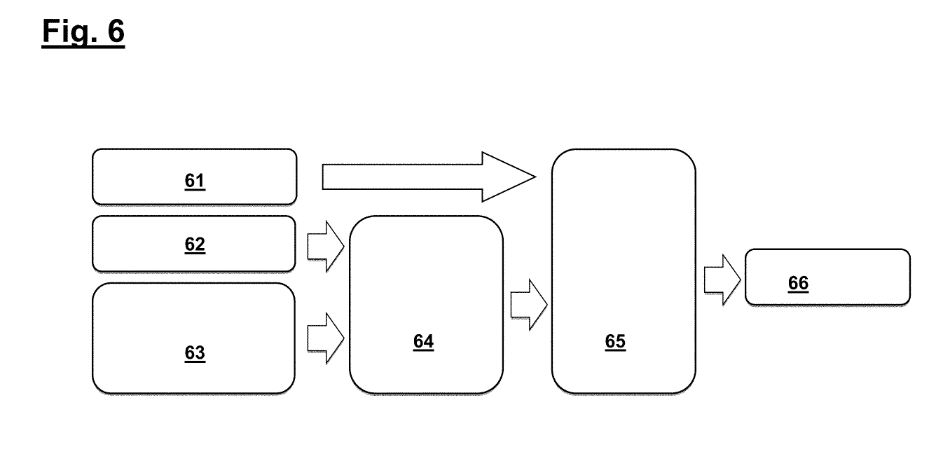

FIG. 6 is a block diagram illustrating the basic concept used in the signal assessment method according to the teachings of the present disclosure. In this case, a tolerance range (block 64) is generated or determined based on a reference signal 62 and the specification or predefinition of a respective tolerance (block 63). A check (block 65) is then performed to determine whether a recorded signal 61 is within the tolerance range and the subsequent assessment (block 66) is carried out on the basis of this check according to the present disclosure.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for assessing signals comprising:
defining a tolerance range based on at least one predefined geometric figure and a desired curve, wherein the at least one predefined geometric figure is moved along the desired curve for at least partially determining the tolerance range, and the desired curve is a time-dependent profile of a desired value for relevant signals; and
determining whether a signal is within the defined tolerance range over a predefined time period.

2. The method of claim 1, wherein defining the tolerance range further comprises assigning, to the tolerance range, a range of values which is covered by the at least one predefined geometric figure when shifting the figure in a graph that associates one or more signal value over time.

3. The method of claim 1, wherein the tolerance range is determined using at least two geometric figures which differ from one another.

4. The method of claim 3, wherein defining the tolerance range further comprises interpolating in a region of the desired curve which remains between the at least two geometric figures.

5. The method of claim 3, wherein the at least two geometric figures differ from one another in terms of their size.

6. The method of claim 3, wherein each of the at least two geometric figures is shifted along the desired curve to at least partially define the tolerance range.

7. The method of claim 1, wherein the at least one predefined geometric figure comprises a circle.

8. The method of claim 1, wherein the at least one predefined geometric figure comprises an ellipse.

9. The method of claim 1, wherein the at least one predefined geometric figure comprises a rectangle.

10. The method of claim 1, wherein the at least one predefined geometric figure is a multidimensional figure.

11. The method of claim 10, wherein the multidimensional figure comprises a sphere.

12. The method of claim 10, wherein the multidimensional figure comprises an ellipsoid.

13. The method of claim 1, wherein the signal is a measurement signal.

14. The method of claim 1, wherein the signal is a simulation result.

15. A device for assessing signals as defined in the method of claim 1, wherein the assessment checks whether a signal is within the defined tolerance range.

16. The method of claim 1 further comprising identifying the signal as a successful assessment in response to the signal being within the defined tolerance range for the entire predefined time period.

17. The method of claim 1 further comprising identifying the signal as an unsuccessful assessment in response to the signal being outside of the tolerance range for at least a portion of the predefined time period.

18. A method for assessing signals comprising:
positioning a geometric figure along a desired signal;
moving the geometric figure along the desired signal such that the desired signal is within the geometric figure;
defining a tolerance range for the desired signal based on a boundary of the geometric figure as it moves along the desired signal; and
assessing an input signal as either positive or negative based on the tolerance range for a specific time period.

19. The method of claim 18 further comprising:
identifying the input signal as a positive assessment in response to the input signal being within the defined tolerance range for the entire specific time period; and
identifying the input signal as a negative assessment in response to the signal being outside the tolerance range for at least a portion of the specific time period.

20. The method of claim 18, wherein at least two geometric figures are positioned on the desired signal and each of the figures is moved along the desired signal to define the tolerance range.
